(19) United States
(12) Patent Application Publication
(10) Pub. No.: US 2010/0207355 A1
(43) Pub. Date: Aug. 19, 2010

(54) LIFTING DEVICE FOR TOW CAR

(76) Inventor: Jong Mun Wang, Jeollanam-do (KR)

Correspondence Address: CHRISTOPHER PAUL MITCHELL, 888 16TH ST., NW, SUITE 800, WASHINGTON, DC, 20006, US

(21) Appl. No.: 12/670,858

(22) PCT Filed: Jul. 23, 2008
(86) PCT No.: PCT/KR2008/004309

§ 371 Date: Jan. 26, 2010

(30) Foreign Application Priority Data
Jul. 26, 2007 (KR) 10-2007-0075312

(51) Int. Cl. B60P 3/07; B60P 3/12; B60P 3/075

(52) U.S. Cl. 280/402

(57) ABSTRACT

A lifting device for a tow car is disclosed. The lifting device includes a guide bracket fixed to a tow car, a lifting bracket slidably connected to the guide bracket, a lifting driving cylinder to move the lifting bracket up and down, a folding bracket pivotally connected to the lifting bracket, a rotating bracket inserted into the folding bracket, an extendable bracket inserted into the rotating bracket so as to move in an axial direction, an extension driving cylinder to move the extendable bracket forward and backward, a connecting unit connected to the extendable bracket and a car to be towed, and a winch unit connected to a car to be towed so as to draw the car to be towed, or connected to any one of the folding bracket, the rotating bracket, the extendable bracket and the connecting unit so as to integrally lift up them.

### TECHNICAL FIELD

The present invention relates to a lifting device for a tow car, and more particularly, to a lifting device for a tow car, having an ascending/descending structure capable of being easily connected with a car to be towed and capable of preventing damage to the towed car during towing, and having a structure capable of minimizing damage due to a load of the towed car and shock during towing.

### BACKGROUND ART

Generally, a tow car is a special car for towing a car which cannot be driven, such as a wrecked car by accident, or an illegally parked car. Such a tow car is equipped with a towing device for lifting a bottom of a car to be towed, or a towing device for lifting a front portion of a car to be towed.

A conventional tow car tows a car by supporting a bottom of a car to be towed using a towing triangular frame, a towing pole and a towing hook, and by lifting the car to be towed using a crane device by a predetermined height. However, the conventional tow car has shortcomings such that it is inconvenient to fixedly connect the towing triangular frame and the towing hook to the bottom of the car to be towed and the connecting work takes much time.

Also, the towed car may be damaged due to contact between the bottom of the towed car and a towing rope of the crane device, and safety accident may occur because a worker is positioned under the car to be towed in order to connect the towing hook to the car to be towed.

To solve the above problems, Korean Utility Model Registration No. 0284543 discloses a front wheel lifting device of a tow car to lift front wheels of a car to be towed. Referring to FIG. 4, the front wheel lifting device of a tow car disclosed in Korean Utility Model Registration No. 0284543 includes a forward/backward moving frame 1 which is mounted to a car body frame (P) so as to move forward and backward, a towing cylinder 2 which is pivotally hingedly coupled to the forward/backward moving frame 1, an underlifter 3 which is pivotally hingedly coupled to an end of the towing cylinder 2 and is link-coupled to a fixing bracket 2a mounted directly under the car body frame (P) by means of a coupling bracket 2b, and a supporting holder 4 which is pivotally coupled to a front end of the underlifter 3 in order to support front wheels of a car to be towed. The above device can simply support front wheels of a car to be towed, and thereby can prevent damage of a car body during towing.

However, because the front wheel lifting device of a tow car disclosed in Korean Utility Model Registration No. 0284543 has a link structure, it has problems such that connecting portions of the link may be easily damaged due to a load of the towed car and shock during towing, and the cylinder may be damaged due to shock applied to the cylinder when operating the link.

### DISCLOSURE OF INVENTION

### Technical Problem

Therefore, the present invention has been made in view of the above problems, and it is an object of the present invention to provide a lifting device for a tow car, having an ascending/descending structure capable of being easily connected with a car to be towed and capable of preventing damage to the towed car during towing, and having a structure capable of minimizing damage due to a load of the towed car and shock during towing.

### Technical Solution

The above object can be accomplished by the provision of a lifting device for a tow car, comprising: a guide bracket fixed to a rear end portion of a tow car, the guide bracket having a guide space formed therethrough in an up/down direction and a slot formed long in front of the guide space; a lifting bracket including a horizontal part provided with a folding hinge, a vertical part extended upward from a rear end portion of the horizontal part, a connecting part protrudingly formed rearward from a rear end portion of the vertical part, and a guide part formed long in an up/down direction at an end of the connecting part, the guide part being inserted into the guide space of the guide bracket to slide along the guide space, and the connecting part being connected to the guide bracket so as to slide along the slot of the guide bracket; a lifting driving cylinder having an end connected to the guide bracket, and the other end connected to the lifting bracket, so as to move the lifting bracket up and down; a folding bracket provided with a folding hinge at a rear end portion thereof, the folding hinge of the folding bracket being connected to the folding hinge of the lifting bracket so as to be pivoted relatively to the lifting bracket in a direction of being lifted up and down with respect to the lifting bracket, and the folding bracket being formed with a rotating shaft supporting hole at a front end portion thereof; a rotating bracket formed with a rotating shaft at a rear end portion thereof and a guide hole extended long in a longitudinal direction at a front end portion thereof, the rotating shaft being inserted into the rotating shaft supporting hole of the folding bracket; an extendable bracket having a rear end portion inserted into the guide hole of the rotating bracket so as to reciprocatingly move in an axial direction, and a front end portion formed with a horizontal hinge; an extension driving cylinder having an end connected to the rotating bracket and the other end connected to the extendable bracket so as to reciprocatingly move the extendable bracket forward and backward; a connecting unit provided with a horizontal hinge at a middle portion thereof and connecting parts at both end portions thereof, the horizontal hinge of the connecting unit being connected to the horizontal hinge of the extendable bracket, and the connecting parts of the connecting unit being connected to a car to be towed; and a winch unit mounted to a tow car, the winch unit being connected to a car to be towed so as to draw the car to be towed, or connected to any one of the folding bracket, the rotating bracket, the extendable bracket and the connecting unit so as to pull and integrally lift up the folding bracket, the rotating bracket, the extendable bracket and the connecting unit.

Also, the guide bracket is provided with a ratchet gear extended long in an up/down direction on one side or both sides from the slot, and the lifting bracket is mounted with a ratchet lever, the ratchet lever being caught by a gear tooth of the ratchet gear when the lifting bracket moves down.

Also, the connecting unit includes a pivoting bracket having the horizontal hinge connected to the horizontal hinge of the extendable bracket at a middle portion thereof, and width-adjusting brackets respectively connected to both end portions of the pivoting bracket so as to be reciprocatingly moved in a width direction, the width-adjusting brackets being formed with the connecting parts at both ends thereof.

### ADVANTAGEOUS EFFECTS

According to the above constitution, the lifting device for a tow car of the present invention has an ascending/descending structure capable of being easily connected with a car to be towed and capable of preventing damage to the towed car during towing, and has a structure capable of minimizing damage due to a load of the towed car and shock during towing.

### BRIEF DESCRIPTION OF THE DRAWINGS

FIG. 1 is a perspective view illustrating a lifting device for a tow car according to an exemplary embodiment of the present invention.

FIG. 2 is an exploded perspective view illustrating the lifting device for a tow car according to an exemplary embodiment of the present invention.

FIG. 3 is a side view illustrating the lifting device for a tow car according to an exemplary embodiment of the present invention.

FIG. 4 is a side view illustrating a conventional lifting device for a tow car.

### *BRIEF DESCRIPTION OF REFERENCE NUMERALS

10 guide bracket
11 guide space
12 slot
13 ratchet gear
14 pedestal part
20 lifting bracket
21 horizontal part
22 vertical part
23 connecting part
24 guide part
26 ratchet lever
30 lifting driving cylinder
40 folding bracket
41 folding hinge
42 rotating shaft supporting hole
50 rotating bracket
51 rotating shaft
52 guide hole
60 extendable bracket
61 horizontal hinge
70 extension driving cylinder
80 connecting unit
81 pivoting bracket
82a, 82b width-adjusting bracket
83a, 83b connecting part
90 winch unit

### BEST MODE FOR CARRYING OUT THE INVENTION

Hereinafter, preferred embodiments of a lifting device for a tow car according to the present invention will be described in detail with reference to the annexed drawings.

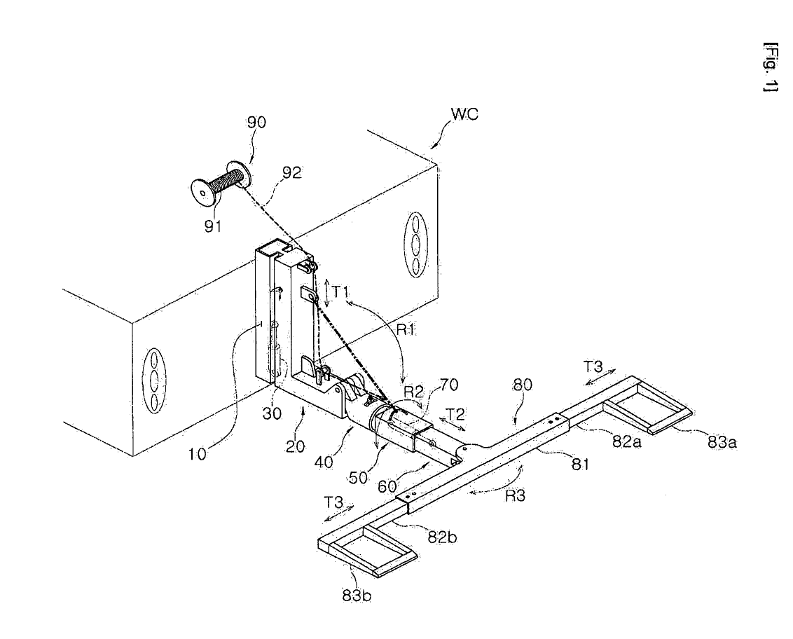

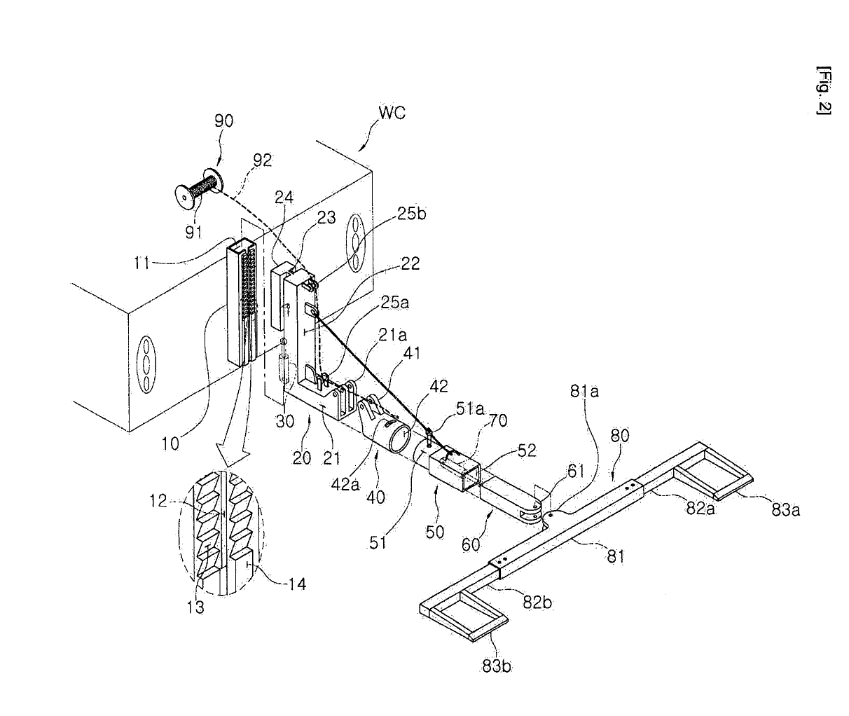

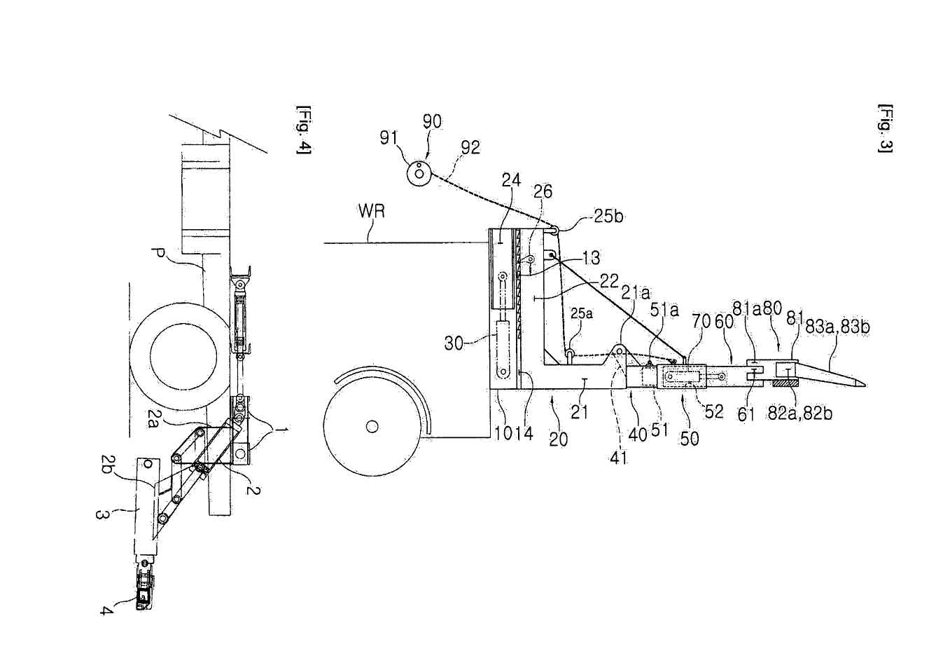

FIG. 1 is a perspective view illustrating a lifting device for a tow car according to an exemplary embodiment of the present invention, FIG. 2 is an exploded perspective view illustrating the lifting device for a tow car according to an exemplary embodiment of the present invention, and FIG. 3 is a side view illustrating the lifting device for a tow car according to an exemplary embodiment of the present invention.

Referring to the drawings, a lifting device for a tow car according to the present invention comprises a guide bracket 10, a lifting bracket 20, a lifting driving cylinder 30, a folding bracket 40, a rotating bracket 50, an extendable bracket 60, an extension driving cylinder 70, a connecting unit 80 and a winch unit 90.

The guide bracket 10 is mounted to a rear end portion of a tow car (WC), in order to guide ascending/descending movement of the lifting bracket 20 and to fix the raised lifting bracket 20 to a raised position, thereby preventing falling of the raised lifting bracket 20. Referring to the drawings, the guide bracket 10 has a guide space 11 formed through the guide bracket 10 in an up/down direction, into which a guide part 24 of the lifting bracket 20 is inserted to slide along. The guide bracket 10 also has a slot 12 formed long in an up/down direction in front of the guide space 11, through which a connecting part 23 connecting a vertical part 22 and the guide part 24 of the lifting bracket 20 is fitted. The guide bracket 10 is further provided with a ratchet gear 13 formed long in an up/down direction on one side or on both sides from the slot 12. The lifting bracket 20 is provided with a ratchet lever 26 which is caught by the ratchet gear 13 so as to stop the lifting bracket 20 at a raised position. The guide bracket 10 is further provided with a pedestal part 14 at a position below the ratchet gear 13, by which a lower end portion of the vertical part 22 of the lifting bracket 20 is supported when external force is applied to the lifting bracket 20.

The lifting bracket 20 is supported by the guide bracket 10, and ascends or descends in an up/down direction (T1) with the folding bracket 30 connected to the lifting bracket 20. The lifting bracket 20 takes down the connecting unit 80 so as to be connected to a car to be towed (not shown), or is raised to lift up the car to be towed connected with the connecting unit 80 or to move in a normal state, i.e., in a non-towing state. Referring to the drawings, the lifting bracket 20, including a horizontal part 11 and a vertical part 12 connected to each other, is formed in a generally L-shape. The folding bracket 40 is connected to a front end portion of the horizontal part 11, and the guide part 14 is connected to a rear end portion of the horizontal part 11 by means of the connecting part 13, so that the lifting bracket 20 is supportedly connected to the guide bracket 10. In other words, the lifting bracket 20 includes the horizontal part 21 provided with folding hinges 21a at a front end portion thereof, to which folding hinges 41 of the folding bracket 40 is hingedly connected, the vertical part 22 extended upward from a rear end portion of the horizontal part 21, the connecting part 23 protruded rearward from a rear end portion of the vertical part 22, and the guide part 24 formed long in an up/down direction at an end of the connecting part 23. The above-structured lifting bracket 20 is supportedly connected to the guide bracket 10 so as to be lifted up and down, by the guide part 24 inserted into the guide space 11 of the guide bracket 10 to slide along the guide space 11 and the connecting part 23 fitted through the slot 12 of the guide bracket 10 to slide along the slot 12. The lifting bracket 20 is provided with supporting rollers 25a and 25b for supporting a cable 92 of the winch unit 90 and changing a moving direction of the cable 92. The vertical part 22 of the lifting bracket 20 is mounted with the ratchet lever 26 at a position corresponding to the ratchet gear 13 of the guide bracket 10. The ratchet lever 26 is caught by the ratchet gear 13 when the lifting bracket 20 moves down.

So as to move the lifting bracket 20 in the up/down direction (T1), the lifting driving cylinder 30 is mounted inside the guide bracket 20 in such a manner that one end of the lifting driving cylinder 30, i.e., a cylinder case, is connected to the guide bracket 10, and the other end of the lifting driving cylinder 30, i.e., a cylinder rod, is connected to the lifting bracket 20.

The folding bracket 40 is connected to the lifting bracket 20 so as to be pivoted in a direction (R1) of being lifted up. In a non-towing state, the folding bracket 40 is pivoted to lift up the rotating bracket 50 connected to a front end portion of the folding bracket 40, and is folded to the rear end portion of the tow car (WC). Referring to the drawings, the folding bracket 40 is provided with the folding hinges 41 at the rear end portion thereof, which are connected to the folding hinges 21a provided at the front end portion of the lifting bracket 20. Therefore, the folding bracket 40 is connected to the lifting bracket so as to be pivoted in the direction (R1) of being lifted up and down. In other words, the folding bracket 40 is connected to the lifting bracket 20 so as to be pivoted relatively to the lifting bracket 20 in the direction (R1) of being lifted up and down with respect to the lifting bracket 20. The rotating bracket 50 is rotatably connected to the front end portion of the folding bracket 40. For this, the folding bracket 40 is formed with a rotating shaft supporting hole 42 at the front end portion thereof, into which a rotating shaft 51 provided at the rear end portion of the rotating bracket 50 is supportedly inserted. A rotational range of the rotating bracket 50, which is rotatably provided by the rotating shaft 51 inserted into the rotating shaft supporting hole 42, should be restricted to a predetermined range. To achieve this, a stopper 51a is protrudingly formed upward from an upper portion of the rotating shaft 51 of the rotating bracket 50, and a stopping slot 42a is formed by cutting an upper portion of an area formed with the rotating shaft supporting hole 41 in a width direction. The stopper 51a is fitted through the stopping slot 42a.

The rotating bracket 50 is rotatably connected to the folding bracket 40 so as to be rotated in the width-inclination direction (R2) when a relative inclination between the tow car (WC) and the towed car is changed on a curve during towing. Referring to the drawings, the rotating shaft 51 is formed at the rear end portion of the rotating bracket 50, and is inserted into the rotating shaft supporting hole 42 of the folding bracket 40. A guide hole 52 is formed long in a longitudinal direction at the front end portion of the rotating bracket 50, into which the extendable bracket 60 is supportedly inserted so as to slide in a longitudinal direction (T2). In other words, the rotating shaft 51 of the above-structured rotating bracket 50 is rotatably inserted into the rotating shaft supporting hole 42 of the folding bracket 40, and the extendable bracket 60 is inserted into the guide hole 52 of the rotating bracket 50.

The extendable bracket 60 serves to adjust an overall length of the towing device. A rear end portion of the extendable bracket 60 is inserted into the guide hole 52 of the rotating bracket 50, so that the extendable bracket 60 can be reciprocatingly moved in an axial direction (T2). Horizontal hinges 61 are formed at a front end portion of the extendable bracket 60, to which the connecting unit 80 is connected.

So as to reciprocatingly move the extendable bracket 60 forward and backward (T2), the extension driving cylinder 70 is mounted inside the rotating bracket 50 in such a manner that an end of the extension driving cylinder 70, i.e., a cylinder case, is connected to the rotating bracket 50, and the other end of the extension driving cylinder 70, i.e., a cylinder rod, is connected to the extendable bracket 70.

The connecting unit 80 serves to be connected with a car to be towed. The connecting unit 80 is provided with horizontal hinges 81a at a middle portion thereof, which are connected to the horizontal hinges 61 of the extendable bracket 70, so that the connecting unit 80 can be rotated in a left/right direction (R3) on a horizontal plane. The connecting unit 80 is also provided with connecting parts 83a and 83b at both end portions thereof, to which a car to be towed is connected. Referring to the drawings, the connecting unit 80 includes a pivoting bracket 81 provided with the horizontal hinges 81a at a middle portion thereof which are connected to the horizontal hinges 61 of the extendable bracket 60 so as to be rotated in the left/right direction (R3) on a horizontal direction, width-adjusting brackets 82a and 82b respectively connected to both end portions of the pivoting bracket 81 so as to be reciprocatingly moved in a width direction (T3), and the connecting parts 83a and 83b coupled to respective ends of the width-adjusting brackets 82a and 82b, to which a car to be towed is connected. Although it is illustrated in the drawings that front wheels of a car to be towed are to be fixedly caught by the connecting parts 83a and 83b, the connecting parts 83a and 83b of the connecting unit 80 may be formed in various structures according to a structure of a car to be towed. For instance, the connecting parts 83a and 83b may have a structure which is connected to an axle of a car to be towed or is connected to a body frame of a car to be towed.

The winch unit 90 serves to draw a car to be towed by connecting a cable 92 wound on a drum 91 to a car to be towed. In order to lift up and fold the folding bracket 40, the rotating bracket 50, the extendable bracket 60 and the connecting unit 80 to the rear end portion of the tow car (WR), the winch unit 90 is mounted to the tow car (WR) so as to be connected to the rotating bracket 50 to pull the same, thereby the folding bracket 40, the rotating bracket 50, the extendable bracket 60 and the connecting unit 80 being integrally lifted up.

### INDUSTRIAL APPLICABILITY

Since the lifting device for a tow car according to the present invention has an ascending/descending structure, it can be applied to a device capable of being easily connected with a car to be towed, capable of preventing damage to the towed car during towing, and capable of minimizing damage due to a load of the towed car and shock during towing.

1. A lifting device for a tow car, comprising:
a guide bracket fixed to a rear end portion of a tow car, the guide bracket having a guide space formed therethrough in an up/down direction and a slot formed long in front of the guide space;
a lifting bracket including a horizontal part provided with a folding hinge, a vertical part extended upward from a rear end portion of the horizontal part, a connecting part protrudingly formed rearward from a rear end portion of the vertical part, and a guide part formed long in an up/down direction at an end of the connecting part, the guide part being inserted into the guide space of the guide bracket to slide along the guide space, and the connecting part being connected to the guide bracket so as to slide along the slot of the guide bracket;
a lifting driving cylinder having an end connected to the guide bracket, and the other end connected to the lifting bracket, so as to move the lifting bracket up and down;
a folding bracket provided with a folding hinge at a rear end portion thereof, the folding hinge of the folding bracket being connected to the folding hinge of the lifting bracket so as to be pivoted relatively to the lifting bracket in a direction of being lifted up and down with respect to the lifting bracket, and the folding bracket being formed with a rotating shaft supporting hole at a front end portion thereof;
a rotating bracket formed with a rotating shaft at a rear end portion thereof and a guide hole extended long in a longitudinal direction at a front end portion thereof, the rotating shaft being inserted into the rotating shaft supporting hole of the folding bracket;
an extendable bracket having a rear end portion inserted into the guide hole of the rotating bracket so as to reciprocatingly move in an axial direction, and a front end portion formed with a horizontal hinge;
an extension driving cylinder having an end connected to the rotating bracket and the other end connected to the extendable bracket so as to reciprocatingly move the extendable bracket forward and backward;
a connecting unit provided with a horizontal hinge at a middle portion thereof and connecting parts at both end portions thereof, the horizontal hinge of the connecting unit being connected to the horizontal hinge of the extendable bracket, and the connecting parts of the connecting unit being connected to a car to be towed; and
a winch unit mounted to a tow car, the winch unit being connected to a car to be towed so as to draw the car to be towed, or connected to any one of the folding bracket, the rotating bracket, the extendable bracket and the connecting unit so as to pull and integrally lift up the folding bracket, the rotating bracket, the extendable bracket and the connecting unit.

2. The lifting device for a tow car according to claim 1, wherein the guide bracket is provided with a ratchet gear extended long in an up/down direction on one side or both sides from the slot, and the lifting bracket is mounted with a ratchet lever, the ratchet lever being caught by a gear tooth of the ratchet gear when the lifting bracket moves down.

3. The lifting device for a tow car according to claim 1, wherein the connecting unit includes a pivoting bracket having the horizontal hinge connected to the horizontal hinge of the extendable bracket at a middle portion thereof, and width-adjusting brackets respectively connected to both end portions of the pivoting bracket so as to be reciprocatingly moved in a width direction, the width-adjusting brackets being formed with the connecting parts at both ends thereof.

4. The lifting device for a tow car according to claim 2, wherein the connecting unit includes a pivoting bracket having the horizontal hinge connected to the horizontal hinge of the extendable bracket at a middle portion thereof, and width-adjusting brackets respectively connected to both end portions of the pivoting bracket so as to be reciprocatingly moved in a width direction, the width-adjusting brackets being formed with the connecting parts at both ends thereof.
